(19) United States
(12) Patent Application Publication
(10) Pub. No.: US 2003/0035586 A1
(43) Pub. Date: Feb. 20, 2003

(54) Decoding compressed image data

(76) Inventors: Jim Chou, Berkeley, CA (US); Kannan Ramchandran, Berkeley, CA (US)

Correspondence Address: WILSON SONSINI GOODRICH & ROSATI, 650 PAGE MILL ROAD, PALO ALTO, CA, 943041050

(21) Appl. No.: 10/146,458

(22) Filed: May 14, 2002

Related U.S. Application Data
(60) Provisional application No. 60/292,025, filed on May 18, 2001.

(51) Int. Cl. G06K 9/36

(52) U.S. Cl. 382/233; 382/239; 382/251; 382/268; 375/240.29

(57) ABSTRACT

Image data encoded in accordance with a block transform coding scheme may be processed by estimating from the encoded image data a discontinuity threshold for detecting artificial edges introduced by the block transform coding scheme. Once the encoded image data is decoded, differences between pairs of pixels disposed along a block boundary of the decoded image may be determined. If the difference between a given pair of pixels is less than the discontinuity threshold, the given pair of pixels may be adjusted to reduce the difference below a visibility threshold, thereby improving the quality of the decoded image by reducing or eliminating blocking artifacts.

### REFERENCE TO RELATED APPLICATIONS

The present application claims priority from U.S. provisional application No. 60/292,025 filed May 18, 2001. U.S. provisional application No. 60/292,025 is hereby incorporated herein by reference in its entirety.

### BACKGROUND

1. Field of Invention

The present invention generally relates to processing of image data, such as still images and video, and more particularly, to systems and methods for decoding compressed image data.

2. Description of Related Art

As evidenced by the increasing popularity of the JPEG still image compression standard and the MPEG-1, -2, -4 video compression standards, block transform coding has proven to be simple, yet effective, for image and video compression. The basic approach utilized by these block coding schemes involves dividing the image into a number of n×n blocks and then individually transforming, quantizing and encoding each block so as to reduce the amount of data required to be transmitted or stored. Although these block coding schemes perform adequately for relatively low levels of compression, compression at higher compression ratios (such as those typically required for transmission over wireless or other bandwidth constrained networks) can lead to noticeable “blocking” artifacts in the decoded image. These artifacts typically appear as artificial rectangular discontinuities between block boundaries (that are introduced by the lossy compression of the original image) and are often the most noticeable image degradation in block transform coding systems.

Existing approaches have attempted to alleviate these problems by performing sophisticated post-processing techniques aimed at “deblocking” the image without destroying relevant image information. Image-adaptive filtering, projection on convex sets (POCS), wavelet denoising, Markov random fields, and overcomplete wavelet representations, for example, have led to improved visual quality and improved subjective quality of the decoded image. These deblocking approaches, however, typically require large amounts of computation time or large amounts of memory in order to process each image. As a result, these approaches may be unacceptable or undesirable for use in real-time applications, such as streaming or multicasting of video images, or on portable devices having limited power, memory or computational capabilities.

Therefore, in light of the deficiencies of existing approaches, there is a need for improved systems and methods for decoding compressed image data, such as still images and video. It is also desired that these improved systems and methods have relatively low computational complexity in order to enable use in real-time applications or portable devices.

### SUMMARY OF THE INVENTION

Embodiments of the present invention alleviate many of the foregoing problems by providing improved systems and methods for decoding compressed image data. In one embodiment, image data encoded in accordance with a block transform coding scheme is processed by estimating from the encoded image data a discontinuity threshold for detecting artificial edges introduced by the block transform coding scheme. This process may involve, for example, determining a per-pixel estimate of quantization error based on the estimated quantization error of each coefficient of each block of the encoded image data. Once the encoded image data is decoded, differences between pairs of pixels disposed along a block boundary of the decoded image may be determined. If the difference between a given pair of pixels is less than the discontinuity threshold, the given pair of pixels may be adjusted to reduce the difference below a visibility threshold, thereby improving the quality of the decoded image by reducing or eliminating blocking artifacts.

In another embodiment of the present invention, image data encoded in accordance with a block coding scheme is processed by using an estimator to estimate from the encoded image data a discontinuity threshold for detecting artificial edges. The encoded image data is then decoded by a decoder, and a smoothing unit determines differences between pairs of pixels disposed along a block boundary of the decoded image. If the difference between a given pair of pixels is less than the discontinuity threshold, the smoothing unit adjusts the given pair of pixels to reduce the difference below a visibility threshold. In order to further reduce distortion (noise) in the decoded image, the smoothing unit may be further configured to smooth differences between the adjusted pixels and pixels adjacent to the adjusted pixels, thereby attenuating any new discontinuities introduced by the smoothing unit.

By reducing the complexity and computational requirements for deblocking image data, embodiments of the present invention provide significant advantages over existing approaches. For example, excluding forward and inverse discrete cosine transformations, embodiments of the present invention may be performed with approximately O(K) additions and multiplications for an image having K pixels. In contrast, existing approaches typically require anywhere from O(KlogK) to O(K²) additions and multiplications in order to achieve similar results. As a result, the lower computational load required by embodiments of the present invention enable these embodiments to be used in real-time applications, such as streaming or multicasting of video images, or on portable devices having limited power, memory or computational capabilities. Moreover, due to the relative simplicity of the deblocking approach, embodiments of the present invention may also be easily incorporated within existing systems, without requiring extensive modifications of the decoder unit.

### BRIEF DESCRIPTION OF THE DRAWINGS

These and other features and advantages of the present invention will become more apparent to those skilled in the art from the following detailed description in conjunction with the appended drawings in which:

FIG. 1 illustrates a block diagram of an exemplary encoder that may be used in connection with embodiments of the present invention;

FIG. 2 illustrates a block diagram of an exemplary decoder for decoding compressed image data in accordance with an embodiment of the present invention;

FIG. 3 illustrates an exemplary method in flow chart form for decoding compressed image data in accordance with an embodiment of the present invention; and

FIGS. 4A and 4B illustrate an exemplary image decoded without post-processing and decoded with post-processing in accordance with the present invention, respectively.

### DETAILED DESCRIPTION

Embodiments of the present invention provide systems and methods for decoding compressed image data. The following description is presented to enable a person skilled in the art to make and use the invention. Descriptions of specific embodiments or applications are provided only as examples. Various modifications, substitutions and variations of embodiments will be apparent to those skilled in the art, and the generic principles defined herein may be applied to other embodiments and applications without departing from the spirit and scope of the invention. The present invention should therefore not be limited to the described or illustrated embodiments, and should be accorded the widest scope consistent with the principles and features disclosed herein.

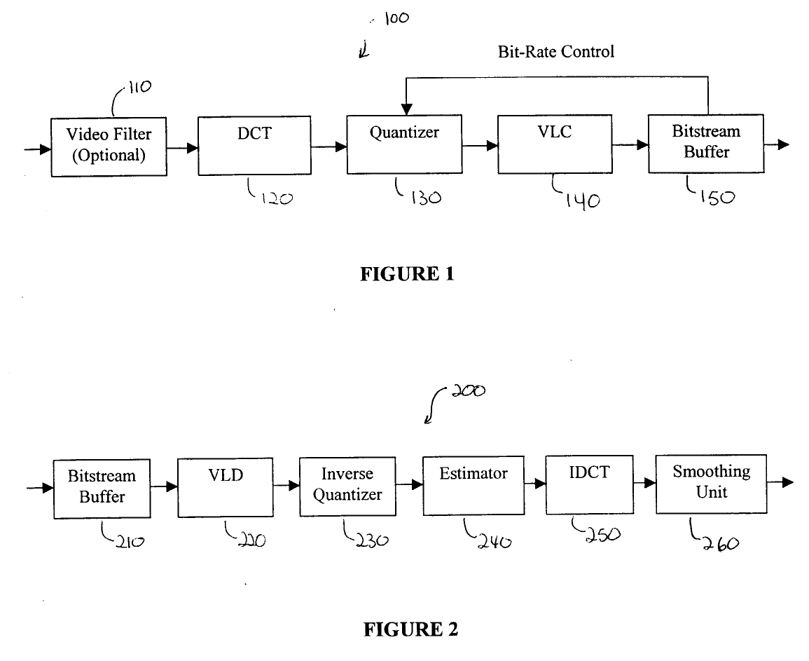

Referring to FIG. 1, a block diagram of an exemplary encoder that may be used in connection with embodiments of the present invention is illustrated generally at 100. As illustrated, the exemplary encoder includes a filter unit 110, a DCT unit 120, a quantizer 130, a variable length coder 140 and a bit stream buffer 150. In operation, the filter unit 110 may be used to convert the incoming image data into a format that can be more easily compressed without adversely affecting the perceived quality of the resulting image. For example, because the human visual system is less sensitive to changes in chrominance than changes in luminance, the filter unit 110 may be configured to convert the incoming data stream from a RGB color space to a YCbCr color space and then quantize the chrominance values so as to reduce the amount of information needed to represent each pixel. Once the filter unit 110 filters the image data, the DCT unit 120 divides the image data into n×n blocks (typically 8×8 blocks) and performs a discrete cosine transform (DCT) on each block. This process essentially decomposes the image data within each block into underlying spatial frequencies and generates a block of DCT coefficients that represent a “weighting” value for each of the n×n orthogonal basis patterns that may be added together to produce the original image. The output of the DCT unit 120 is then applied to a quantizer 120 that reduces the precision of the DCT coefficients by, for example, scaling the DCT coefficients by a quantizer scale code or more coarsely quantizing higher frequency DCT coefficients in accordance with a predefined quantization matrix. The objective of this quantization process is to force as many of the DCT coefficients to zero (or near zero) as possible within the boundaries of the prescribed bit-rate and video quality parameters. The variable length coder 140 then compresses the output of the quantizer 130 using, for example, predefined Huffman tables, and the output of the valuable length coder 140 is stored in a bitstream buffer 150 for transmission.

In order to avoid underflow or overflow of the bitstream buffer 150, the bitstream buffer 150 may be configured to generate a rate control signal that causes the quantizer 130 to adjust the level of quantization for each block of DCT coefficients by, for example, adjusting the quantization scale factor or switching to a different quantization matrix. For applications requiring steep compression ratios, such as applications requiring transmission over wireless or other bandwidth constrained networks, the bitstream buffer 150 may cause the quantizer 130 to significantly increase the level of quantization for the DCT coefficients. This steep quantization of DCT coefficients increases the quantization noise introduced into each block of DCT coefficients. When conventional decoders attempt to decode the image data, this quantization noise may cause discontinuities between blocks of the decoded image. These so-called “blocking” artifacts typically appear as rectangular discontinuities in the decoded image and are often the most noticeable image degradation in block transform coding systems.

Embodiments of the present invention alleviate many of the foregoing problems by incorporating mechanisms within the decoder that enable the decoder to efficiently detect artificial edges caused by lossy compression and then remove these artificial edges using a one-time non-linear smoothing. These embodiments of the present invention are guided by two simple principles: (a) smoothing artificial discontinuities (due to quantization noise) between blocks improves image quality; and (b) smoothing actual image edges degrades image quality. Embodiments of the present invention accomplish these objectives by performing efficient estimates of the quantization noise for each block of DCT coefficients in order to determine a discontinuity threshold. This discontinuity threshold enables the decoder to distinguish between artificial edges and actual image edges. In other words, if a discontinuity in the decoded image exceeds the discontinuity threshold, the discontinuity is likely an actual image edge and smoothing these edges may degrade image quality. If the discontinuity in the decoded images is less than the discontinuity threshold, the discontinuity is likely an artificial edge due to quantization noise and smoothing these edges may improve image quality. Accordingly, once the image data is decoded via an inverse discrete cosine transform (IDCT), differences between pixels disposed along a block boundary of the decoded image may be determined. If the difference between a given pair of pixels is less than the discontinuity threshold, the given pair of pixels may be adjusted in order to reduce the difference below a visibility threshold. These embodiments of the present invention are computationally simple, and compare favorably with the best existing approaches for deblocking image data (which are often significantly more computationally complex).

Referring to FIG. 2, a block diagram of an exemplary decoder for decoding compressed image data in accordance with an embodiment of the present invention is illustrated generally at 200. As illustrated, the exemplary decoder includes a bitstream buffer 210, a variable length decoder 220, an inverse quantizer 230, an estimator 240, an IDCT unit 250 and a smoothing unit 260. The bitstream buffer 210, variable length decoder 220, inverse quantizer 230 and IDCT unit 250 essentially perform the inverse operations performed by the bitstream buffer, variable length coder, quantizer and DCT unit of the encoder in order to decode the encoded image data. Notably, the exemplary decoder of FIG. 2 further includes an estimator 240 and a smoothing unit 260 that may be used to efficiently detect artificial edges and remove the artificial edges using a one-time non-linear smoothing. It is these aspects of the exemplary decoder that enable the decoder to improve image quality with a relatively small increase in computational complexity.

With regard to the estimator 240, the objective of this unit is to determine a discontinuity threshold that may be used by the smoothing unit 260 to distinguish artificial edges caused by quantization noise from actual image edges. In order to accomplish this objective in an efficient manner, the estimator 240 utilizes a maximum-likelihood framework to derive estimates for the reconstructed DCT coefficients and for the quantization error of each DCT coefficient. For example, making the reasonable assumption that the DC coefficient of each block can be modeled as a Gaussian random variable and the AC coefficients of each block can be modeled as zero-mean Laplacian random variables, the maximum likelihood estimate Ĉᵤᵥ of each DCT coefficient within each n×n block can then be calculated using the following equation:

$${\hat{C}}_{uv} = E [ y \vert {l}_{uv} \leq y \leq {r}_{uv} ] = \frac{{\int }_{{l}_{uv}}^{{r}_{uv}} {yp}_{uv} ( y ) ⅆ y}{{\int }_{{l}_{uv}}^{{r}_{uv}} {p}_{uv} ( y ) ⅆ y} u , v = 1 , … , n \qquad ( 1 )$$

where uv indexes the spatial frequency of each n×n block, pᵤᵥ(y) represents the probability distribution for the DCT coefficient at frequency uv before quantization, and lᵤᵥ and rᵤᵥ represent the left and right boundaries, respectively, of the quantization bin in which Ĉᵤᵥ must lie. Because the estimator 240 does not have access to the original DCT coefficients at the decoder, the parameters for pᵤᵥ(y) (e.g., the sample mean and sample variance) can be estimated from the moments of the quantized DCT coefficients.

Using the same assumptions described above, and using the maximum likelihood estimate Ĉᵤᵥ of each DCT coefficient from equation (1), the quantization error Eᵤᵥ of each DCT coefficient in a given n×n block can be estimated in accordance with the following equation:

$${E}_{uv} = \frac{{\int }_{{l}_{uv}}^{{r}_{uv}} {( y - {\hat{C}}_{uv} )}^{2} {p}_{uv} ( y ) ⅆ y}{{\int }_{{l}_{uv}}^{{r}_{uv}} {p}_{uv} ( y ) ⅆ y} u , v = 1 , … , n \qquad ( 2 )$$

The estimator 240 may then use the quantization error of each DCT coefficient determined from equation (2) to determine a per-pixel estimate of quantization error T in the spatial domain for each n×n block. For example, the estimator 240 may exploit the fact that the DCT is a unitary transform (e.g., energy-preserving) so that the mean-squared quantization error in the DCT domain is also the mean-squared quantization error in the spatial domain. Accordingly, the estimator 240 may determine the per-pixel estimate of quantization error T as follows:

$$T = \frac{1}{{n}^{2}} {\sum }_{u = 0}^{n - 1} {\sum }_{v = 0}^{n - 1} {E}_{uv} \qquad ( 3 )$$

The per-pixel estimate of the quantization error T determined in accordance with equation (3) provides a good estimate of the actual quantization error introduced at the encoder, which has been confirmed through simulation over a large class of images and video frames.

The estimator 240 may then use the per-pixel estimate of the quantization error T to determine a discontinuity threshold for detecting a maximal blocking discontinuity between pixels disposed along a block boundary in the decoded image. For example, in one embodiment, the discontinuity threshold may be determined in accordance with equation (4), which tends to provide a good estimate of maximal blocking discontinuities:

t=2\sqrt{T} (4)

Once the estimator 240 determines the discontinuity threshold, the IDCT unit 250 of the decoder performs an inverse discrete cosine transform (IDCT) on the encoded image data in order to reproduce the original image. However, because the encoder may have introduced significant quantization error, the decoded image may have blocking artifacts that degrade the image quality. As such, the smoothing unit 260 may detect these blocking artifacts using the discontinuity threshold and then smooth these blocking artifacts below a visibility threshold v. In one embodiment, this visibility threshold v may be approximated as cf, where f represents the average intensity of the block under examination and c represents a constant (which may be between 0.02 and 0.03 according to Weber's law).

In operation, the smoothing unit 260 may be configured to detect artificial discontinuities by determining differences between pixels on either side of a block boundary. For example, if the ith column of an M×N decoded image x is expressed as x_{.,l}, and assuming the image was encoded using 8×8 blocks, then a difference vector d_{col} across a column boundary may be calculated in accordance with the following equation:

d_{col}=[(x_{.,8}−x_{:,9})^{T}(x_{:,16}−x_{:,17})^{T} . . . (x_{·,N-8}−x_{·,N-7})^{T}]^{T} (5)

A similar approach may be used to form a distance vector d_{row} across row boundaries. If the magnitude of any entry in d_{col} or d_{row} is less than the discontinuity threshold determined by the estimator 240, then that entry is treated as a blocking discontinuity. In order to ensure that these artificial discontinuities are reduced below a level that can be perceived by the human visual system, the corresponding pixels are adjusted by an amount that reduces the difference below a visibility threshold. For example, if the difference a given pair of pixels x andy is less than the discontinuity threshold, the pair of pixels may be adjusted as follows:

\hat{x}=x−ad

ŷ=y+ad

$$α d = \frac{t - v}{2 t} d$$

where t represents the discontinuity threshold, v represents the visibility threshold, and d represents the difference between the pair of pixels.

For entries of d_{col} or d_{row} that exceed the discontinuity threshold, the pair of pixels may be adjusted by at instead of ad, where at equals (t−v)/2. By adjusting these boundary pixels, embodiments of the present invention may reduce much of the blockiness of the decoded image even if the discontinuity threshold t is set too low (which can happen since the discontinuity threshold may be based on a mean-squared (not a maximum) estimate of quantization error), while still preserving much of the edge information.

It should be noted that whenever the smoothing unit 260 adjusts boundary pixels, the smoothing unit 260 may introduce new discontinuities between the boundary pixels and pixels adjacent to the boundary pixels. In order to reduce these new discontinuities, the smoothing unit 260 may be configured to adjust the adjacent pixels by, for example, replacing the values of the adjacent pixels with an average of itself and the adjusted boundary pixel. This additional smoothing may be repeated for other pixels within the n×n block until the center of the block is reached. Alternatively, because blocking artifacts typically disappear after a few iterations of the smoothing described above, the smoothing of adjacent pixels may be limited to one or two iterations.

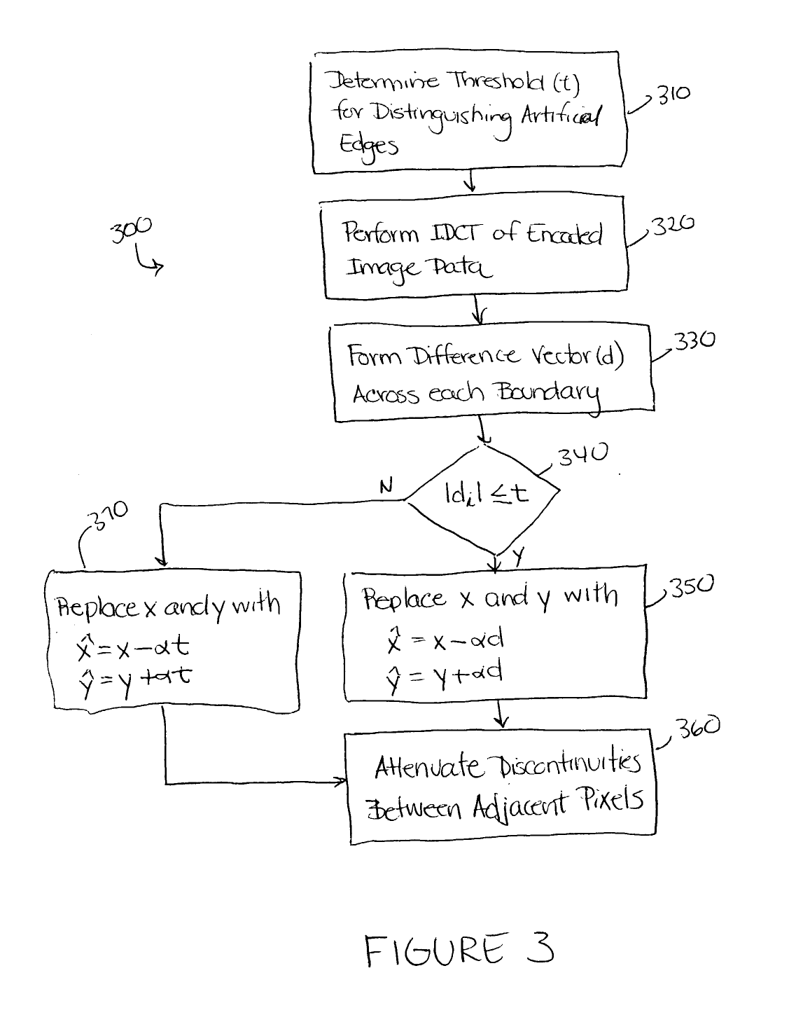

Referring to FIG. 3, an exemplary method in flow chart form for decoding compressed image data in accordance with an embodiment of the present invention is illustrated generally at 300. As illustrated, the exemplary method may be initiated at step 310 where incoming encoded image data is processed to determine a discontinuity threshold for distinguishing artificial edges from actual image edges. This process may involve estimating a per-pixel quantization error from the quantization error of each DCT coefficient as described above in connection with the embodiment of FIG. 2. Once the discontinuity threshold has been determined, an inverse discrete cosine transform may be performed at step 320 in order to reproduce the original image. The exemplary method may then perform post-processing of the decoded image in order to smooth any artificial blocking artifacts that were introduced by the lossy compression at the encoder. This process may begin at step 330 where differences between pixels disposed along a block boundary are determined in order to form a distance vector. If any entry in the distance vector is less than the discontinuity threshold at step 340, then the pixels corresponding to the entry are adjusted at step 350 in order to reduce the pixel value on one side of the block boundary by ad and increase the pixel value on the other side of the block boundary by the same amount so as to reduce the difference between the boundary pixels below a visibility threshold. In this context, ad may be determined based on a visibility threshold and the difference between the corresponding pixels. Once the boundary pixels have been adjusted, the exemplary method may proceed to step 360 where pixels adjacent to the boundary pixels are adjusted by, for example, replacing the values of the adjacent pixels with an average of itself and the adjusted boundary pixel.

Referring back to step 340, if any entry in the distance vector is greater than the discontinuity threshold, then the pixels corresponding to the entry are adjusted at step 370 in order to reduce the pixel value on one side of the block boundary by at and increase the pixel value on the other side of the block boundary by the same amount so as to remove blocky artifacts. Once the boundary pixels have been adjusted, the exemplary method may similarly proceed to step 360 where pixels adjacent to the boundary pixels are adjusted in order to attenuate an new discontinuities between the adjusted pixels and pixels adjacent to the adjusted pixels that were caused by the initial smoothing process.

For a fair comparison regarding performance, the algorithm of the present invention was executed on a test Lena image commonly used in the multimedia processing community. As can be seen from the Table 1, the algorithm performs relatively well and achieves roughly the same gains as other more computationally complex algorithms at all bit rates tested. The algorithm also provides significant gains over conventional JPEG decoding without any smoothing of blocking artifacts.

| | Compression Bit Rate | | |
|---|---|---|---|
| Reconstruction Algorithm | .15 bpp | .24 bpp | .43 bpp |
| JPEG | 26.44 dB | 29.58 dB | 32.36 dB |
| Embodiments of Present Invention | 27.50 dB | 30.37 dB | 32.81 dB |
| Projection-based spatially adaptive | 27.58 dB | 30.43 dB | 32.81 dB |
| Overcomplete wavelet representations | 27.58 dB | 30.37 dB | 32.46 dB |

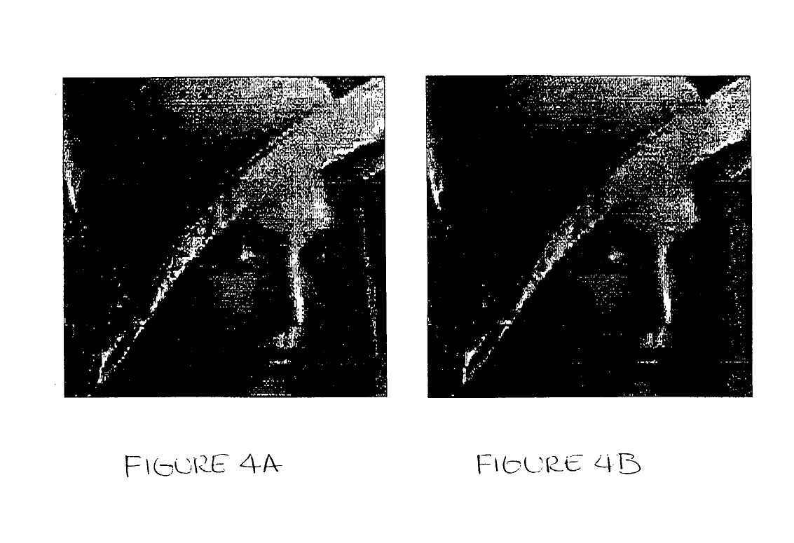

Embodiments of the present invention also improve the subjective visual quality of block-transform coded image data. For example, FIGS. 4A and 4B illustrate an exemplary image decoded without post-processing and decoded with post-processing in accordance with the present invention, respectively. The decoded JPEG image of FIG. 4A is shown to be very blocky. After applying the algorithm of the present invention in FIG. 4B, however, most of the annoying blocking artifacts have been smoothed.

In addition to the improved image quality mentioned above, embodiments of the present invention also reduce the computational complexity compared to other existing approaches. For example, excluding forward and inverse discrete cosine transformations, embodiments of the present invention may be performed with approximately O(K) additions and multiplications for an image having K pixels. In contrast, existing approaches typically require anywhere from O(KlogK) to O(K²) additions and multiplications in order to achieve similar results. As a result, the lower computational load required by embodiments of the present invention enables these embodiments to be used in real-time applications, such as streaming or multicasting of video images, or on portable devices having limited power, memory or computational capabilities.

While the present invention has been described with reference to exemplary embodiments, it will be readily apparent to those skilled in the art that the invention is not limited to the disclosed or illustrated embodiments but, on the contrary, is intended to cover numerous other modifications, substitutions, variations and broad equivalent arrangements that are included within the spirit and scope of the following claims.

What is claimed is:

1. A method for decoding image data, the method comprising:
receiving image data encoded in accordance with a block transform coding scheme;
estimating from the encoded image data a discontinuity threshold for detecting artificial edges introduced by the block transform coding scheme;
decoding the encoded image data;
determining differences between pairs of pixels disposed along a block boundary of the decoded image; and
if the difference between a given pair of pixels is less than the discontinuity threshold, adjusting the given pair of pixels to reduce the difference below a visibility threshold.

2. The method of claim 1, wherein the step of estimating comprises determining a maximum-likelihood estimate of coefficients within a block of the block encoded image data.

3. The method of claim 2, wherein the step of estimating further comprises estimating a quantization error of each coefficient based the maximum-likelihood estimates.

4. The method of claim 3, wherein the step of estimating further comprises determining a per-pixel estimate of quantization error based on the estimated quantization error of each coefficient.

5. The method of claim 4, wherein the per-pixel estimate of quantization error equals a mean-squared error of the estimated quantization error of each coefficient.

6. The method of claim 1, wherein the step of decoding comprises performing at least an inverse discrete cosine transform (IDCT) of the encoded image data.

7. The method of claim 1, wherein the step of determining comprises determining differences between pairs of pixels disposed along each row and column boundary of the decoded image.

8. The method of claim 1, wherein the step of adjusting comprises performing non-linear smoothing of the given pair of pixels.

9. The method of claim 8, wherein the step of non-linear smoothing comprises:
reducing the given pixel disposed on one side of the block boundary by an amount determined from the discontinuity threshold and the visibility threshold; and
increasing the given pixel disposed on the other side of the block boundary by the same amount.

10. The method of claim 1, further comprising smoothing differences between the adjusted pixels and pixels adjacent to the adjusted pixels.

11. A system for decoding image data, the system comprising:
a receiving unit configured to receive image data encoded in accordance with a block transform coding scheme;
an estimator configured to estimate from the encoded image data a discontinuity threshold for detecting artificial edges;
a decoder configured to decode the encoded image data;
a smoothing unit configured to determine differences between pairs of pixels disposed along a block boundary of the decoded image, and if the difference between a given pair of pixels is less than the discontinuity threshold, to adjust the given pair of pixels to reduce the difference below a visibility threshold.

12. The system of claim 11, wherein the estimator is configured to determine a maximum-likelihood estimate of coefficients within a block of the block encoded image data.

13. The system of claim 12, wherein the estimator is further configured to estimate a quantization error of each coefficient based the maximum-likelihood estimates.

14. The system of claim 13, wherein the estimator is further configured to determine a per-pixel estimate of quantization error based on the estimated quantization error of each coefficient.

15. The system of claim 14, wherein the per-pixel estimate of quantization error equals a mean-squared error of the estimated quantization error of each coefficient.

16. The system of claim 10, wherein the decoder is configured to perform at least an inverse discrete cosine transform (IDCT) of the encoded image data.

17. The system of claim 10, wherein the smoothing unit is configured to determine differences between pairs of pixels disposed along each row and column boundary of the decoded image.

18. The system of claim 10, wherein the smoothing unit is configured to perform a non-linear smoothing of the given pair of pixels to reduce the difference below the visibility threshold.

19. The system of claim 10, wherein the smoothing unit is configured to:
reduce the pixel disposed on one side of the block boundary by an amount determined from the discontinuity threshold and the visibility threshold; and
increase the pixel disposed on the other side of the block boundary by the same amount.

20. The system of claim 10, wherein the smoothing unit is further configured to smooth differences between the adjusted pixels and pixels adjacent to the adjusted pixels.
